(19) United States
(12) Patent Application Publication
(10) Pub. No.: US 2026/0093417 A1
(43) Pub. Date: Apr. 2, 2026

(54) STORAGE DEVICE AND METHOD FOR OPERATING STORAGE DEVICE

(71) Applicant: SK hynix Inc., Icheon-si (KR)

(72) Inventors: Soon Hyun KWON, Icheon-si (KR); Jin Sub KIM, Icheon-si (KR)

(21) Appl. No.: 19/058,694

(22) Filed: Feb. 20, 2025

(30) Foreign Application Priority Data
Sep. 30, 2024 (KR) 10-2024-0132359

(51) Int. Cl. G06F 3/06

(52) U.S. Cl. CPC G06F 3/0659; G06F 3/0604; G06F 3/064; G06F 3/0673

(57) ABSTRACT

A storage device may include a memory and a controller. The memory includes a plurality of memory blocks, each including a plurality of memory cells. The controller may receive a write command for data, and may, in response to the write command, control the memory to write the data to a target memory block with a highest priority, among target memory blocks set to a target cell type corresponding to the data, according to a read operation count and a read defense operation count.

### CROSS-REFERENCE TO RELATED APPLICATION

The present application claims priority under 35 U.S.C. § 119(a) to Korean Patent Application No. 10-2024-0132359 filed in the Korean Intellectual Property Office on Sep. 30, 2024, which is incorporated herein by reference in its entirety.

### BACKGROUND

### 1. Technical Field

Embodiments of the present disclosure generally relate to a storage device and a method for operating a storage device.

### 2. Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

In order to write data to the memory, the storage device may select an open memory block among a plurality of memory blocks included in the memory, and may write the data to the selected open memory block. Generally, the storage device may select an open memory block on the basis of erase counts of the plurality of memory blocks.

### SUMMARY

Various embodiments of the present disclosure are directed to a storage device capable of selecting an open memory block optimized for a cell type corresponding to data to be written, and a method for operating the storage device.

In an aspect, a storage device may include: a memory including a plurality of memory blocks, each including a plurality of memory cells; and a controller configured to receive a write command for data, and, in response to the write command, control the memory to write the data to a target memory block with a highest priority, among target memory blocks set to a target cell type corresponding to the data, according to a read operation count and a read defense operation count.

In another aspect, a method for operating a storage device may include: receiving a write command for data; determining, in response to the write command, target memory blocks set to a target cell type corresponding to the data, selected from a plurality of memory blocks, each including a plurality of memory cells; and writing the data to a target memory block with a highest priority, among the target memory blocks, according to a read operation count and a read defense operation count.

According to the embodiments of the present disclosure, it is possible to select an open memory block optimized for a cell type corresponding to data to be written.

### BRIEF DESCRIPTION OF THE DRAWINGS

FIG. 1 illustrates a storage device according to an embodiment of the present disclosure.

FIG. 2 illustrates a memory of FIG. 1.

FIG. 3 illustrates a storage device according to an embodiment of the present disclosure.

FIG. 4 illustrates an operation in which the storage device according to the embodiment of the present disclosure determines an open memory block for a target cell type.

FIG. 5 illustrates an operation in which the storage device according to the embodiment of the present disclosure determines a first count and a second count for a first target memory block.

FIG. 6 is a flowchart illustrating an operation in which the storage device according to the embodiment of the present disclosure determines whether to perform a read defense operation on a first target memory block.

FIG. 7 illustrates an operation in which the storage device according to the embodiment of the present disclosure determines an open memory block based on a first count and a second count.

FIG. 8 illustrates memory block information according to an embodiment of the present disclosure.

FIG. 9 illustrates a method for operating a storage device according to an embodiment of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present disclosure are described below in more detail with reference to the accompanying drawings. However, the present disclosure may be embodied in different forms and variations, and should not be construed as being limited to the embodiments set forth herein. Rather, the described embodiments are provided so that this disclosure will be thorough and complete, and will fully convey the present disclosure to those skilled in the art to which this disclosure pertains. Throughout the disclosure, like reference numerals refer to like parts throughout the various figures and embodiments of the present disclosure.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

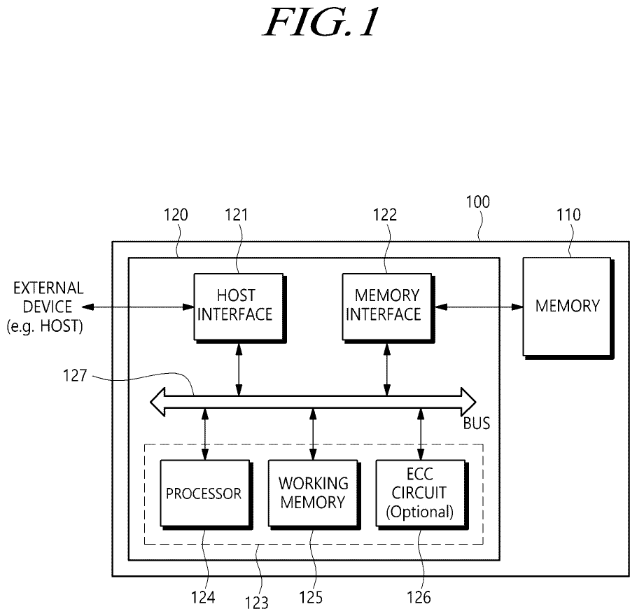

FIG. 1 illustrates a storage device 100 according to an embodiment of the disclosure.

Referring to FIG. 1, the storage device 100 may include a memory 110 for storing data and a controller 120 for controlling the memory 110.

The memory 110 includes a plurality of memory blocks, and operates under the control of the controller 120. Operations of the memory 110 may include, for example, a read operation, a program operation (also referred to as a write operation), and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM), a spin transfer torque random access memory (STT-RAM), and so forth.

The memory 110 may be implemented as a three-dimensional array structure. For example, embodiments of the present disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation, indicated by the command, on the area selected by the address.

The memory 110 may perform a program operation, a read operation, or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (or program), read, erase, and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, may also control the operation of the memory 110 regardless of a request from the host.

The host may be a computer, an ultra-mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol, and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 under the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (or drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or has failed. On the other hand, when a bit error rate is lower than the reference value, the error detection and correction circuit 126 may determine that a corresponding sector is correctable or has passed.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may be configured to provide channels among the components 121, 122, 124, 125, and 126 of the controller 120. The bus 127 may include, for example, a control bus for transferring various control signals, commands, and the like, a data bus for transferring various data, and so forth.

Some components among the above-described components 121, 122, 124, 125, and 126 of the controller 120 may be omitted, or some components among the above-described components 121, 122, 124, 125, and 126 of the controller 120 may be integrated into one component. In addition to the above-described components 121, 122, 124, 125, and 126 of the controller 120, one or more other components may be added.

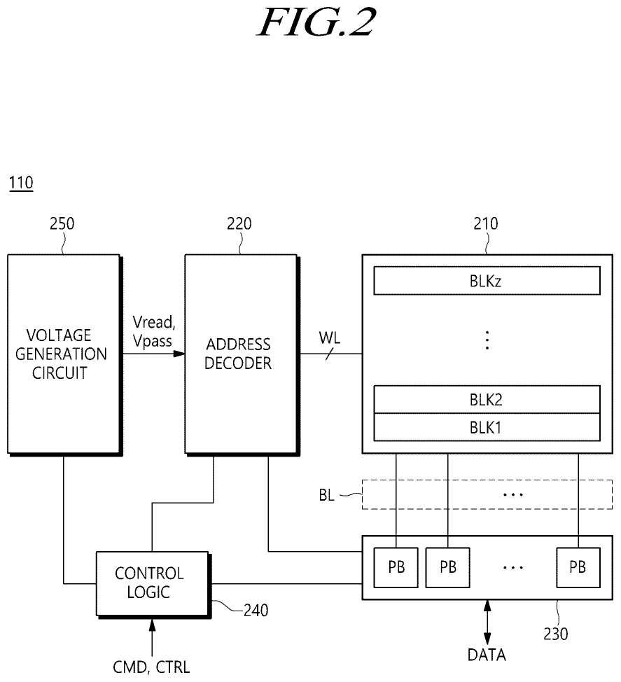

Hereinbelow, the memory 110 will be described in further detail with reference to FIG. 2.

FIG. 2 illustrates the memory 110 of FIG. 1.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal output from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

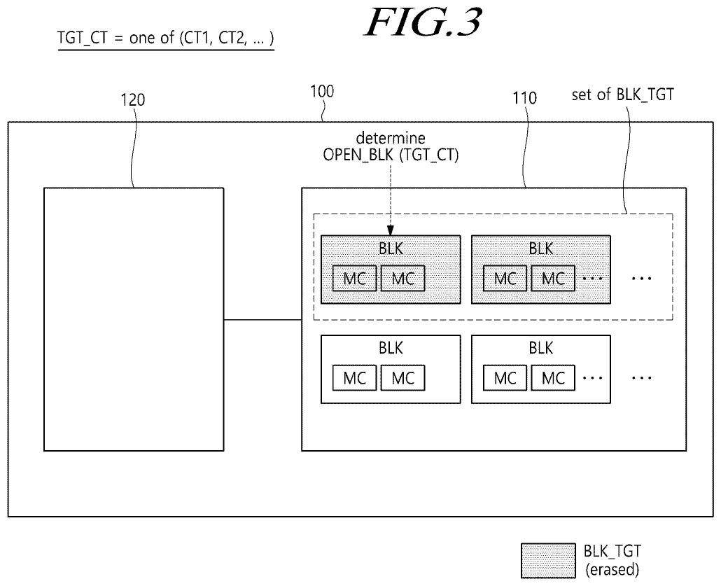

FIG. 3 illustrates a storage device 100 according to an embodiment of the present disclosure.

Referring to FIG. 3, the storage device 100 may include a memory 110 and a controller 120.

The memory 110 may include a plurality of memory blocks BLK. Each of the plurality of memory blocks BLK may include a plurality of memory cells MC.

The cell type of each of the plurality of memory cells MC included in each memory block BLK may be dynamically determined as one of a plurality of cell types CT1, CT2, . . . . That is to say, a memory block previously programmed as one cell type may later be programmed as a different cell type.

The cell type of each of the plurality of memory cells MC may be configured as SLC, MLC, TLC, QLC, etc.

The number of bits of data stored in each of the plurality of memory cells MC is determined by its cell type. For example, if the cell type is determined as SLC, each of the plurality of memory cells MC stores 1 bit of data. For another example, if the cell type is determined as TLC, each of the plurality of memory cells MC stores 3 bits of data. For still another example, if the cell type is determined as QLC, each of the plurality of memory cells MC stores 4 bits of data.

Upon receiving a write command for storing data, the controller 120 may set a cell type corresponding to the data. In other words, based on the data to be written, the controller 120 may determine a target cell type TGT_CT from among the plurality of cell types CT1, CT2, . . . . The controller 120 may then determine an open memory block OPEN_BLK for the target cell type TGT_CT in a set of target memory blocks BLK_TGT selected from the plurality of memory blocks BLK. The open memory block OPEN_BLK is a memory block where the data is to be written.

The controller 120 may determine the target cell type TGT_CT based on the characteristics of the data to be written to the memory 110. For example, when writing data which requires a quick response or data with a high access frequency, the controller 120 may determine the target cell type TGT_CT as SLC. For another example, when writing a large amount of data or data with a low access frequency, the controller 120 may determine the target cell type TGT_CT as TLC or QLC.

The target memory blocks BLK_TGT may be in an erased state, allowing new data to be written to them. The target memory blocks BLK_TGT may also be referred to as free memory blocks.

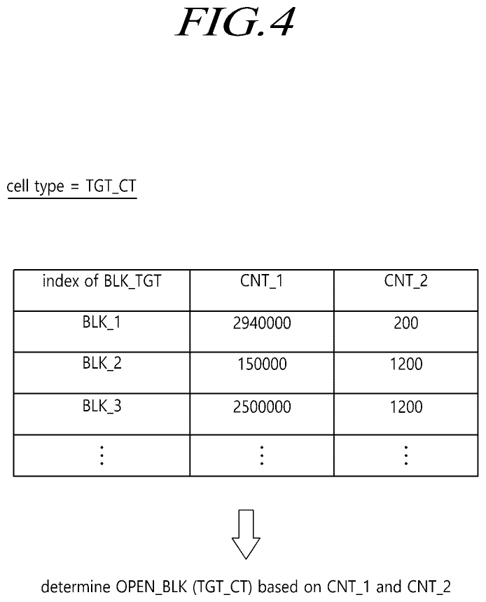

Hereinafter, a specific operation in which the controller 120 of the storage device 100 determines the open memory block OPEN_BLK for the target cell type TGT_CT will be described through FIG. 4.

FIG. 4 illustrates an operation in which the storage device 100 according to the embodiment of the present disclosure determines the open memory block OPEN_BLK for the target cell type TGT_CT.

Referring to FIG. 4, the controller 120 of the storage device 100 may determine the open memory block OPEN_BLK for the target cell type TGT_CT based on a first count CNT_1 and a second count CNT_2 for each of target memory blocks BLK_1, BLK_2, BLK_3, . . . included in the above-described set of target memory blocks BLK_TGT.

In an embodiment, the controller 120 may determine a target memory block with the highest priority among the target memory blocks BLK_1, BLK_2, BLK_3, . . . , based on the first count CNT_1 and the second count CNT_2, as the open memory block OPEN_BLK, and may write data to the open memory block OPEN_BLK. Namely, the target memory block determined as the open memory block OPEN_BLK may be regarded as a memory block with the highest priority according to the first count CNT_1 and the second count CNT_2.

In an embodiment, the first count CNT_1 of a first target memory block among the target memory blocks BLK_1, BLK_2, BLK_3, . . . represents the number of read operations performed on the first target memory block while its cell type is set to the target cell type TGT_CT. This count may also be referred to as a read operation count of the first target memory block.

The second count CNT_2 of the first target memory block represents the number of read defense (or recovery) operations performed on the first target memory block while its cell type is set to the target cell type TGT_CT. This count may also be referred to as a read defense operation count of the first target memory block.

The read defense operation for the first target memory block is an operation of adjusting an optimal read bias for the first target memory block. When a failure occurs during a read operation for the first target memory block, a read defense operation may be performed on the first target memory block.

In an embodiment of the present disclosure, the first count CNT_1 and the second count CNT_2 for the first target memory block are determined based on the target cell type TGT_CT, which represents the cell type of the first target memory block. Accordingly, the controller 120 may assign priority differently depending on the target cell type TGT_CT.

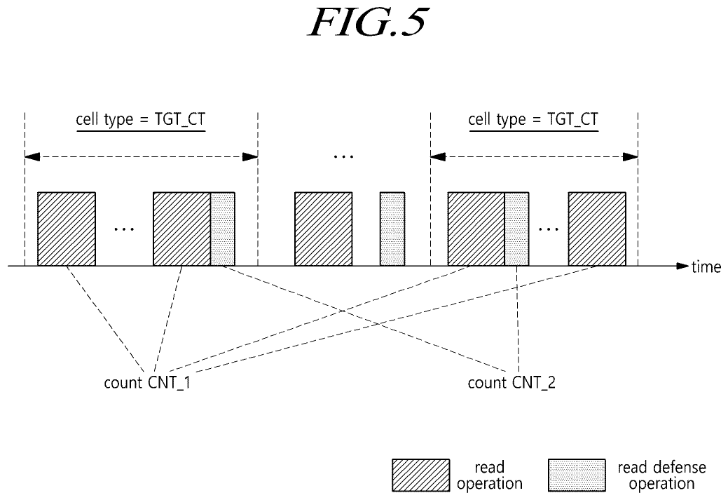

Hereinbelow, the operation of the storage device 100 measuring the first count CNT_1 and the second count CNT_2 for the first target memory block will be described with reference to FIG. 5.

FIG. 5 illustrates an operation in which the storage device 100 according to the embodiment of the present disclosure measures the first count CNT_1 and the second count CNT_2 for the first target memory block.

Referring to FIG. 5, the controller 120 of the storage device 100 may count the number of read operations and the number of read defense operations performed on the first target memory block.

When a read operation is performed while the cell type for the first target memory block is set to the target cell type TGT_CT, the controller 120 may increase the first count CNT_1. That is to say, when the cell type for the first target memory block is set to a different cell type, the first count CNT_1 is not increased, even if a read operation is performed.

When a read defense operation is performed while the cell type for the first target memory block is set to the target cell type TGT_CT, the controller 120 may increase the second count CNT_2. That is to say, when the cell type for the first target memory block is set to a different cell type, the second count CNT_2 is not increased, even if a read defense operation is performed.

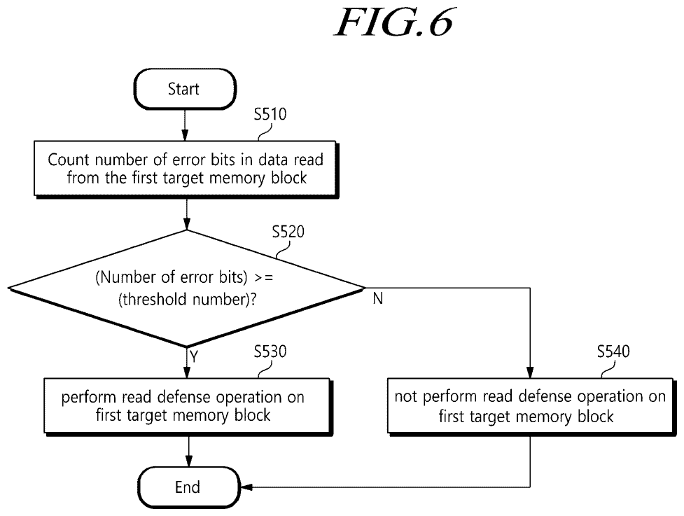

In an embodiment of the present disclosure, whether to perform a read defense operation may be determined based on a result of a read operation. This will be described below in detail with reference to FIG. 6.

FIG. 6 is a flowchart illustrating an operation in which the storage device 100 according to the embodiment of the present disclosure determines whether to perform a read defense operation on the first target memory block.

Referring to FIG. 6, the controller 120 of the storage device 100 may count the number of error bits in data read from the first target memory block when a read operation is performed on the first target memory block (S510).

The controller 120 determines whether the counted number of error bits is equal to or greater than a preset threshold number (S520).

When the counted number of error bits is equal to or greater than the threshold number (S520-Y), the controller 120 may perform a read defense operation on the first target memory block (S530).

On the other hand, when the counted number of error bits is smaller than the threshold number (S520-N), the controller 120 may not perform the read defense operation for the first target memory block (S540).

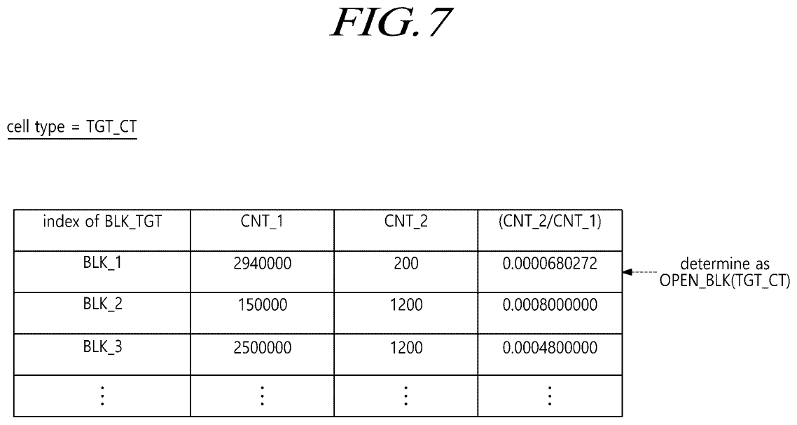

FIG. 7 illustrates an operation in which the storage device 100 according to the embodiment of the present disclosure determines the open memory block OPEN_BLK based on the first count CNT_1 and the second count CNT_2.

Referring to FIG. 7, the controller 120 of the storage device 100 may determine a target memory block with the smallest ratio of the second count CNT_2 to the first count CNT_1 among the target memory blocks BLK_1, BLK_2, BLK_3, . . . included in the set, and designate it as the open memory block OPEN_BLK for the target cell type TGT_CT.

In other words, the controller 120 may determine a target memory block with the smallest ratio of a read defense operation count to a read operation count among the target memory blocks BLK_1, BLK_2, BLK_3, . . . as the target memory block with the highest priority.

In FIG. 7, ratios of the second count CNT_2 to the first count CNT_1 for the target memory blocks BLK_1, BLK_2, BLK_3, . . . are 0.0000680272, 0.0008000000, 0.0004800000, . . . , respectively.

Accordingly, the controller 120 may determine the target memory block BLK_1 with the smallest ratio of the second count CNT_2 to the first count CNT_1 as the open memory block OPEN_BLK for the target cell type TGT_CT.

The controller 120 determines the open memory block OPEN_BLK in this way because optimal performance may be achieved when the target memory block with the smallest ratio of the second count CNT_2 to the first count CNT_1 is set as the open memory block OPEN_BLK for the target cell type TGT_CT.

In a case where the open memory block OPEN_BLK is determined based solely on an erase count, without considering the target cell type TGT_CT as in the conventional method, a target memory block optimized for the target cell type TGT_CT may not be selected as the open memory block OPEN_BLK. For example, a target memory block that provides optimal performance when set to SLC may instead have its cell type set to TLC, rather than SLC.

Because the operational characteristics of the same target memory block can vary depending on a cell type, when the open memory block OPEN_BLK is determined based on the count of read or read defense operations performed on the target memory block set to a different cell type, there is no guarantee that the determined open memory block OPEN_BLK provides performance optimized for the target cell type TGT_CT.

Accordingly, the controller 120 may determine the open memory block OPEN_BLK based solely on the ratio of the second count CNT_2 to the first count CNT_1, excluding the erase count and the count of read or read defense operations performed when the target memory block is set to a different cell type.

If the target cell type TGT_CT is changed to a different cell type, the values of the first count CNT_1 and the second count CNT_2 also change, which may result in a different open memory block OPEN_BLK being selected.

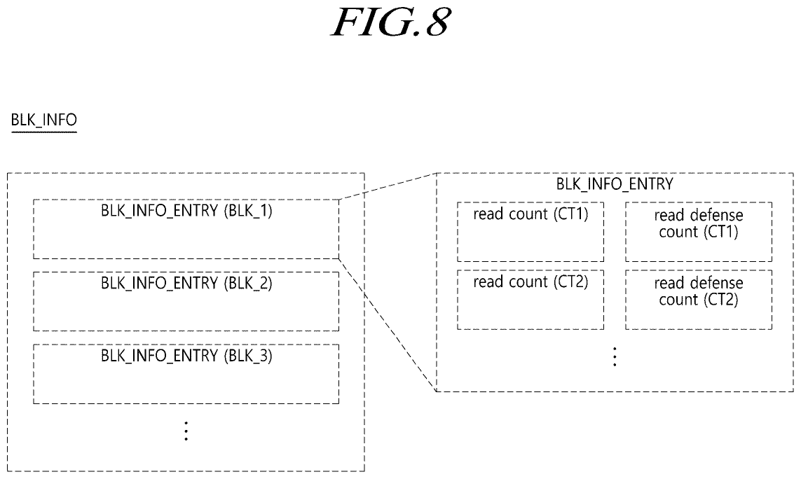

Therefore, the storage device 100 needs to manage, for each of a plurality of cell types, counts of read and read defense operations performed on each target memory block. This process will be described below in detail with reference to FIG. 8.

FIG. 8 illustrates memory block information BLK_INFO according to an embodiment of the present disclosure.

Referring to FIG. 8, the memory block information BLK_INFO may include memory block information entries BLK_INFO_ENTRY for the target memory blocks BLK_1, BLK_2, BLK_3, . . . , respectively. In an embodiment, the memory block information BLK_INFO may be stored in the controller 120, the memory 110, or a separate volatile/non-volatile memory.

A memory block information entry BLK_INFO_ENTRY for a first target memory block BLK_1 among the target memory blocks BLK_1, BLK_2, BLK_3, . . . may store a read operation count and a read defense operation count for the first target memory block when the first target memory block BLK_1 is set to a target cell type.

The target cell type may be set to one of the plurality of cell types CT1, CT2, . . . . Therefore, the memory block information entry BLK_INFO_ENTRY for the first target memory block BLK_1 may store a read operation count and a read defense operation count for each of the plurality of cell types CT1, CT2, . . . .

For example, the memory block information entry BLK_INFO_ENTRY for the target memory block BLK_1 may store that a read operation count is 525000 and a read defense operation count is 1000 when the cell type of the target memory block BLK_1 is set to SLC.

In addition, the memory block information entry BLK_INFO_ENTRY for the target memory block BLK_1 may store that a read operation count is 1700000 and a read defense operation count is 1500 when the cell type of the target memory block BLK_1 is set to TLC.

Accordingly, the controller 120 of the storage device 100 may search for a memory block information entry BLK_INFO_ENTRY corresponding to a specific target memory block in the memory block information BLK_INFO, and may search for a read operation count and a read defense operation count for the target cell type TGT_CT in the searched memory block information entry BLK_INFO_ENTRY.

The controller 120 of the storage device 100 may update the memory block information BLK_INFO at a specific point of time.

For example, the controller 120 may update the memory block information BLK_INFO when at least one of the plurality of memory blocks BLK included in the memory 110 is set to a target cell type. One or more of the plurality of memory blocks BLK may be erased in response to an erase request from a host, or erased in a background operation (e.g., garbage collection or read reclaim), and a cell type for the erased memory blocks may be set to the target cell type described above. At this time, the controller 120 may update the memory block information BLK_INFO.

For another example, the controller 120 may update the memory block information BLK_INFO when at least one of the plurality of memory blocks BLK included in the memory 110 is changed to a closed memory block, or when at least one closed memory block among the plurality of memory blocks BLK is changed to a target memory block. When all pages of a memory block are filled with data, the corresponding memory block is designated as a closed memory block, and the controller 120 may update the memory block information BLK_INFO. A closed memory block can be re-designated as a target memory block after being erased.

For still another example, the controller 120 may update the memory block information BLK_INFO when a read operation or a read defense operation is performed on at least one of the target memory blocks BLK_1, BLK_2, BLK_3, . . . .

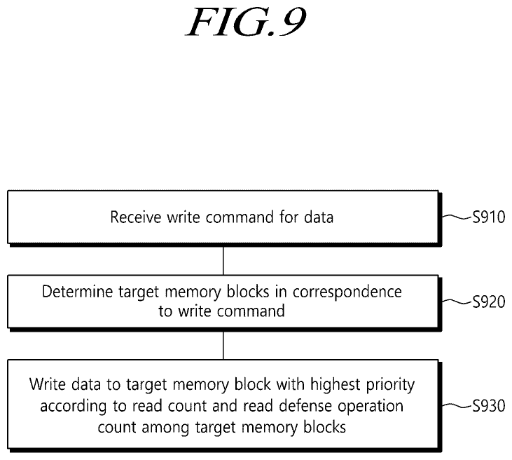

FIG. 9 illustrates a method for operating the storage device 100 according to an embodiment of the present disclosure.

Referring to FIG. 9, the method may include operation S910, in which the storage device 100 receives a write command for data.

The method may include operation S920, in which, in response to the write command, target memory blocks BLK_TGT are determined based on the cell type corresponding to the data, selected from a plurality of memory blocks BLK, each including a plurality of memory cells MC.

The cell type of the plurality of memory cells MC included in each of the plurality of memory blocks BLK may be dynamically determined as one of a plurality of cell types CT1, CT2, . . . .

The method may include operation S930, in which the data is written to a target memory block with the highest priority, determined based on a read operation count and a read defense operation count, among the target memory blocks BLK_TGT. The priority may vary depending on the cell type.

For example, the operation S930 may determine a target memory block with the smallest ratio of a read defense operation count to a read operation count among the target memory blocks BLK_TGT, as the target memory block with the highest priority.

The method may further include an operation of updating memory block information BLK_INFO including memory block information entries BLK_INFO_ENTRY for the target memory blocks BLK_TGT, respectively.

A memory block information entry BLK_INFO_ENTRY for a first target memory block among the target memory blocks BLK_TGT may store a read operation count and a read defense operation count for the first target memory block when the first target memory block is set to a target cell type.

For example, the operation of updating memory block information BLK_INFO may update the memory block information BLK_INFO when at least one of the plurality of memory blocks BLK is set to the target cell type.

For another example, the operation of updating memory block information BLK_INFO may update the memory block information BLK_INFO when at least one of the plurality of memory blocks BLK is changed to a closed memory block, or when at least one closed memory block among the plurality of memory blocks BLK is changed to a target memory block.

For still another example, the operation of updating memory block information BLK_INFO may update the memory block information BLK_INFO when a read operation or a read defense operation is performed on at least one of the target memory blocks BLK_TGT.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device, comprising:
a memory including a plurality of memory blocks, each including a plurality of memory cells; and
a controller configured to receive a write command for data, and, in response to the write command, control the memory to write the data to a target memory block with a highest priority, among target memory blocks set to a target cell type corresponding to the data, according to a read operation count and a read defense operation count.

2. The storage device according to claim 1, wherein the controller determines a priority differently based on a cell type.

3. The storage device according to claim 1, wherein the controller determines a target memory block with a smallest ratio of a read defense operation count to a read operation count, among the target memory blocks, as the target memory block with the highest priority.

4. The storage device according to claim 1, wherein the controller updates memory block information that includes memory block information entries for the target memory blocks,
wherein a memory block information entry for a first target memory block among the target memory blocks stores a read operation count and a read defense operation count for the first target memory block when the first target memory block is set to the target cell type.

5. The storage device according to claim 4, wherein the controller updates the memory block information when a read operation or a read defense operation is performed on at least one of the target memory blocks.

6. The storage device according to claim 4, wherein the controller updates the memory block information when at least one of the plurality of memory blocks is set to the target cell type.

7. The storage device according to claim 4, wherein the controller updates the memory block information when at least one of the plurality of memory blocks is changed to a closed memory block or when at least one closed memory block among the plurality of memory blocks is changed to a target memory block.

8. A method for operating a storage device, comprising:
receiving a write command for data;
determining, in response to the write command, target memory blocks set to a target cell type corresponding to the data, selected from a plurality of memory blocks, each including a plurality of memory cells; and
writing the data to a target memory block with a highest priority, among the target memory blocks, according to a read operation count and a read defense operation count.

9. The method according to claim 8, wherein a priority is determined differently based on a cell type.

10. The method according to claim 8, wherein the writing the data includes determining a target memory block with a smallest ratio of a read defense operation count to a read operation count, among the target memory blocks, as the target memory block with the highest priority.

11. The method according to claim 8, further comprising:
updating memory block information that includes memory block information entries for the target memory blocks,
wherein a memory block information entry for a first target memory block among the target memory blocks stores a read operation count and a read defense operation count for the first target memory block when the first target memory block is set to the target cell type.

12. The method according to claim 11, wherein the updating memory block information includes updating the memory block information when a read operation or a read defense operation is performed on at least one of the target memory blocks.

13. The method according to claim 11, wherein the updating memory block information includes updating the memory block information when at least one of the plurality of memory blocks is set to the target cell type.

14. The method according to claim 11, wherein the updating memory block information includes updating the memory block information when at least one of the plurality of memory blocks is changed to a closed memory block or when at least one closed memory block among the plurality of memory blocks is changed to a target memory block.
